(19) United States
(12) Patent Application Publication
(10) Pub. No.: US 2009/0249312 A1
(43) Pub. Date: Oct. 1, 2009

(54) Process Generation Approach and System for an Integrated Telecom Platform

(75) Inventors: Yongkun Liao, Shenzhen City (CN); Junhua Luo, Shenzhen City (CN); Wei He, Shenzhen City (CN)

Correspondence Address: ERIC CHAN, 42 Pin Oaks Drive, Phoenixville, PA, 19460, US

(73) Assignee: SHENZHEN DONJIN COMMUNICATION TECH CO., LTD., Futain District, Shenzhen City (CN)

(21) Appl. No.: 11/721,682

(22) PCT Filed: Jun. 9, 2006
(86) PCT No.: PCT/CN2006/001274

§ 371 Date: Jun. 14, 2007

(30) Foreign Application Priority Data
Nov. 17, 2005 (CN) 200510101662.9

(51) Int. Cl. G06F 9/45; H04L 29/02

(52) U.S. Cl. 717/140

(57) ABSTRACT

An approach for process generation for computer telephony integration (CTI) of an integrated telecom platform, including the following steps. Step 1: The process input module receives the flow chart input by a user and saves it as a flow chart record file; Step 2: the process coversion module coverts the flow chart record file into the equivalent source codes and saves them as a flow chart coversion output file; Step 3: the process compilation module compiles the flow chart coversion output file and saves it as a flow chart compilation output file. The invention also announces a process generation system for an integrated telecom platform, including the process input module, the process coversion module and the process compilation module. The invention is an ideal system for various CTI applications, allowing easy and fast subsequent development as well as convenient system upgrade and maintenance.

### BACKGROUND OF THE INVENTION

This invention relates to the field of voice communication, to be more specific, a process generation approach and system for an integrated telecom platform.

With the development of telecom services, the focus has been shifted from voice services to value-added services for a better revenue. Needs for value-added services naturally generate needs for platform equipment of such value-added services. However, the value-added services have the following characteristics: (1) the service need is usually very urgent, demanding the equipment to be launched quickly; and if the service is well accepted, the system needs to be expanded for a large capacity; (2) the needs for value-added services keep changing rapidly: typically, a service will be replaced by another in one or two years, therefore, the equipment cost (including hard costs and soft costs) is also a critical factor determining whether the service will be popular or not.

Considering the aforesaid characteristics of the value-added service platform equipment, the current CTI (Computer Telephony Integration) boards have three major defects: First, the complexity of API (Application Programming Interface) on the current board leads to a long subsequent R&D period and high soft costs; Second, the imperfect structure design results in a high hard unit cost and thus a high hard cost of equipment for board fabrication; Third, the single-board processing density and the cascade expandability cannot satisfy the need for high density and subsequent expandability of some systems.

The Integrated Telecom Platform (ITP) developed in a bid to solve the above problems is a telecom service switch platform for service applications including call switching, teleconference, call dispatching, IVR (Interactive Voice Response) applications, digital recording, call center (Automatic Call Distribution System), echo elimination and IP gateway. It features various interface boards and resource boards, a large capacity distributed switching network, a highly reliable CPU board with a powerful processing capacity, various data I/O devices, a redundant power supply and large capacity storage devices. The invention is one of the modules used to realize the integrated telecom platform.

### BRIEF SUMMARY OF THE INVENTION

The invention aims to provide a process generation approach and system for an integrated telecom platform to eliminate the defect of long R&D period caused by the complexity of the aforesaid API interface and enable users to easily and quickly customize programs for CTI functions by using the process generation system with a graphic interface.

The technical solution of the invention to solve the technical problems is to develop a process generation approach for computer telephony integration (CTI) of an integrated telecom platform, including the following steps:

Step 1: The process input module receives the flow chart input by a user and saves it as a flow chart record file;
Step 2: The process coversion module coverts the flow chart record file into equivalent source codes and saves them as a flow chart coversion output file;
Step 3: The process compilation module compiles the flow chart coversion output file and saves it as a flow chart compilation output file.

In accordance with Step (S1) of the invention, the flow chart input by the user is saved in a computer in the format of flow chart file, which has the equivalent contents with the flow chart so input.

In accordance with the invention, the flow chart provides a process definition represented in a graphic manner and consists of at least one basic component connected in a certain way.

Step (S2) of the invention also include the process to identify the component type of the flow chart record file and then inquire the description file corresponding to the same.

In Step (S2) of the invention, the said source code adopts ANSI C language, and the coversion of the flow chart record file into ANSI C source code is unidirectional.

In accordance with Step (S3) of the invention, the compilation is to compile C source code of process definition with the standard C compiler in the operating system and output the process execution code.

In accordance with the invention, the compilation output is a dynamic link library (DLL) file if the operating system is WIN32 and a dynamic library file if the operating system is Linux.

The invention provides a process generation system for computer telephony integration (CTI) of an integrated telecom platform, which consists of
Process input module: it provides a graphic interface, receives the flow chart input by a user and saves it as a flow chart record file and then sends it to the process conversion module;
Process coversion module: it coverts the flow chart record file into equivalent source codes and saves them as a flow chart coversion output file, then sends it to the process compilation module;
Process compilation module: it compiles the flow chart coversion output file and saves it as a flow chart compilation output file.

In accordance with the invention, the process input module includes basic components and auxiliary components. The basic components include process initializing, functional, status, process restart and branch components; and the auxiliary components include detailed drawing, Help, flags and cycle components.

The aforesaid process compilation module uses the compilation tools provided by Windows or Linux to do the compilation.

The invention is an ideal system for various CTI applications, allowing easy and fast subsequent development as well as convenient system upgrade and maintenance by providing a process generation system with a graphic interface.

### BRIEF DESCRIPTION OF THE DRAWINGS

Drawings and examples are provided herein for further explanation on the Invention. The drawings cover:

FIG. 1 represents the process generation approach for the integrated telecom platform;

FIG. 2 represents the system architecture of the process generation module;

FIG. 3 represents the processing flow chart of the process coversion module;

FIG. 4 represents the processing flow chart of the process compilation module.

### DETAILED DESCRIPTION OF THE INVENTION

A specific implemented case and the related drawings are provided hereinafter for further narration of the invention and the purpose, technical solution and advantages thereof.

FIG. 1 presents the process generation approach, which is integrated in the process generation module for the integrated telecom platform, including the following steps:

Step S100: The process input module receives the flow chart input by a user and saves it as a flow chart record file;

Step S200: The process conversion module converts the flow chart record file to the equivalent source codes, and saves them as a flow chart conversion output file;

Step S300: The process compilation module compiles the flow chart conversion output file and saves it as a flow chart compilation output file;

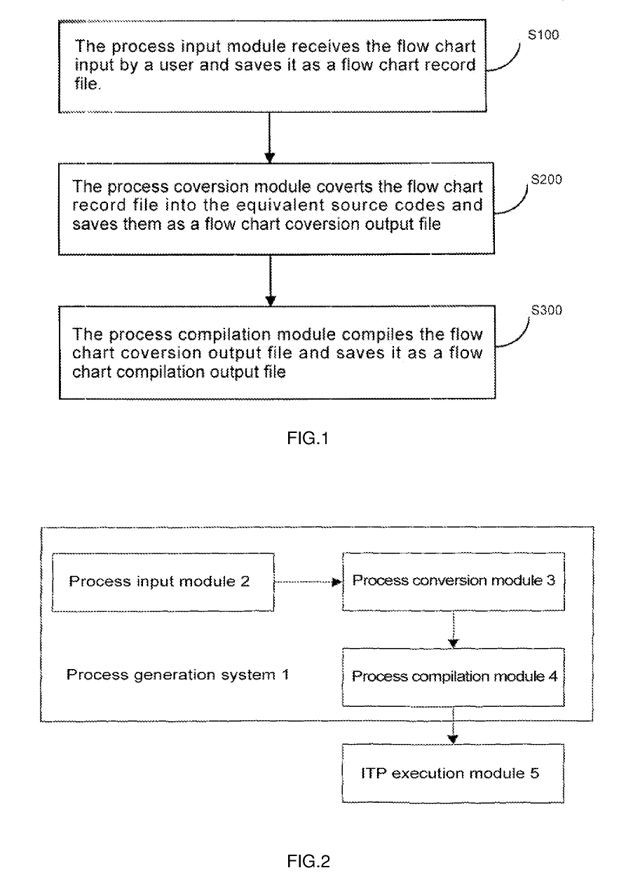

FIG. 2 illustrates the system structure of the process generation module for the integrated telecom platform. The system 1 consists of the process input module 2, the process conversion module 3 and the process compilation module 4. The process input module 2 receives the flow chart input by a user and saves it as a flow chart record file and then sends it to the process conversion module 3; and process conversion module 3 coverts the flow chart record file into equivalent source codes and saves them as a flow chart coversion output file, then sends it to the process compilation module 4; the process compilation module 4 compiles the flow chart coversion output file and saves it as a flow chart compilation output file, then sends it to the ITP execution module 5. The following will provide a further explanation about the aforesaid modules.

The process input module 2 consists of basic components and auxiliary components. The basic components include process initializing, functional, status, process restart and branch components; and the auxiliary components include detailed drawing, Help, flags and cycle components.

Among the aforesaid basic components, the functional components include the command, event and embedded code components. The command component sends command packets; the event component receives at least one parameter from event packets; the system functional component calls the system functions and set function parameters. The embedded code component is a standard C code used to perform arithmetic operation, strings process, etc. Each functional component stands for a segment of C codes, and the code header can provide multiple entry while the code end as the only exit. So a functional component can receive data from multiple basic components but can output data to only one basic component. The program of process restart component stops at entry of a functional component and return to the beginning of the process for restart.

The status component represents that flow program is paused and waits for a trigger of the next event to resume. The status component doesn't correspond to a specific C code, however, it effects the program structure. The entry of status component connects with exit of at least one other component, but its exit can connect with entry of only one component.

A branch component can have only one entry but at least one exit.

A detailed drawing component has only one entry and only one exit, connected to only one basic component respectively.

The Help component provides information about functions of each basic component for easy understanding of the process. It has no direct relation with the process, therefore, it is not connected to any other component. Flag components can be classified into two categories: detailed drawing entry and detailed drawing exit.

Flow chart consists of at least one basic component connected by certain mode. A whole flow chart consists of many detailed drawings, and the detailed drawings can be plain views or embedded detailed drawings. A drawing component has its entry and exit, and the user can shift from a detailed plain view to another drawing. The embedded detailed drawing includes another detailed drawing; the process entry stands for a process start, and the process exit stands for a process end. User can define variables in the flow chart, such as common variables (in variable types supported by standard C language), resource handle and process handle. Any variable that the user defines in a detailed drawing is a global variable which can be seen and used in another detailed drawings.

Users can use variable component to easily define three types of variables: resource handles, process handles and handles supported by standard C. The cycle component has two entries and two exits, providing the For cycling function.

The process input module 2 provides a process generation system with a graphic interface, with the graphic interface, the user can:
(1) Create a new process, ie. create a new application program, which at least consists of one entry component and one exit component. The user can create it by choosing the icons in menu or toolbar, or by the shortcut Ctrl+N, the system will allocate the file name automatically;
(2) Create new detailed drawings. For a detailed plain view component, the entry attribute represents the start of the detailed drawing; no specific requirement for an embedded detailed drawing). Each of them can be created by choosing the icons in menu or toolbar, or by the shortcut Ctrl+Shift+N. The system will ask what kind of detailed drawing you want to creat, and allocate the file name automatically according to the options;
(3) Insert/delete components (basic components or embedded components). Inserting component is to create new components and you should change the connection relationship of the components when doing this. Deleting component is to delete the selected component and its connection relationship from the process. You can choose the icon in menu or toolbar to insert or delete a component, or delete a component with the Delete key;
(4) Set/change component attributes. You can right click the mouse and select Attribute or double click to pop up the Attribute dialog box, you will see the current values and the default values, then you can directly input or select the value to set or change the attribute. For direct input, the system will check the values to pretect from any invalid input. You can choose the icon in menu or toolbar, or Alt+Enter;
(5) Set/change component connection. Changing the connection between components is to change the logical relationship of program, there are three methods to change it: 1. select the source and drag it. 2. select the source, choose “connect” in the menu to complete the operation. 3. the system supports the commands listed in the menu and toolbar;
(6) Automatically show the component connection relationship. when you have completed the setting, the component connections will be automatically displayed on interface by straight line or fold line with an arrow, the arrow end is the source and the arrow head is the destination;
(7) Set /change user-defined variables. you can define the variable type, variable name and default value with variable components. Choose the defined variable, you can modify the default value, delete the variable or rename the variable.
(8) Cut/copy/paste flow charts. When choose one or more components (press Shift or drag mouse when choose), you can cut/copy/paste with the menu bar/toolbar/context menu/shortcut, or Ctrl+X/Ctrl+C/Ctrl+V;
(9) Open flow charts and detailed drawings. Using the process generation tool, you can open the existing flow charts or detailed drawings to edit and modify. you can open the file by the open command in the toolbar/menu bar/shortcut key, or Ctrl+O;
(10) Move components. Choose one or more components (press Shift or drag mouse when choose), then you can click to move the same;
(11) Processing for misoperation. When misoperation occurred, you can recover to the last step with the toolbar/menu bar/shortcut or Ctrl+Z/Alt+Backspace, which provide the Undo function. Besides, Redo function is also supported with the aforesaid methods, or Ctrl+Y/Shift+Alt+Backspace;

To edit the process and set the attribute, you need some important files, such as command packet description file, command packet category list, event packet description file, event packet type list and system function description file.

The command packet description file includes the description for all ITP command packets to be used by the process program. The command packet category list describes the module type, main functions and subfunctions in the ITP system, i.e. it provides packets for description of all main functional modules of a certain module type and all subfunctions under the main functions. The event packet decription file provides decription for all ITP event packets used in the process program. The event packet type list describes the event packets of module types, main functions and subfunctions in the ITP system, ie., it provides event packets describing all main functional modules of a certain module type and all subfunctions of the main functions. The system function description file is defined by ITP execution module 7 so that the system functions provided by ITP execution module 7 can be used; with this file, the process input module will show, with the components, all system functions and related parametes for user to set the attributes.

After the user has completed the process editing, the system will save the information as a flow chart record file. When open the process record file in the process input module 2, the file will reproduce the equivalent flow chart. Detailed drawings does not really exist, they are available when displayed. When the detailed drawings are connected with the current process, the system will allocate IDs and manage such components, and finally generate just one flow chart record file.

The process conversion module 3 is an Exe file, which is integrated with the process input module in the end. The input file is a file generated by the process input module 2, which is then processed by the module 3 to generate an ANSI C code flow chart output file. During the conversion, the command packet description file, event packet description file, public parameter structure file and system function description file will be inqured according to the component type, and the processing procedure thereof is as the follows:

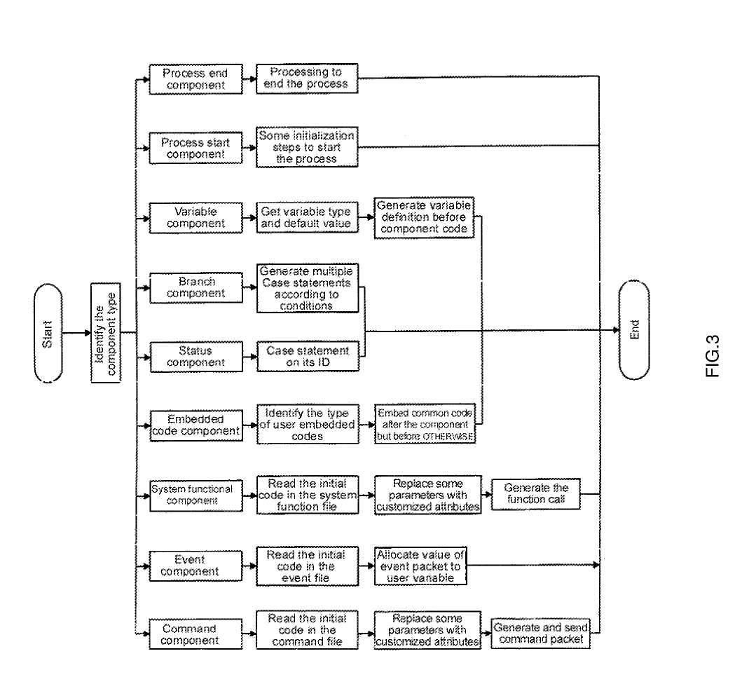

FIG. 3 illustrates the processing of process conversion module 3. As shown in FIG. 3, the process conversion module 3 identifies the component type first, if it is a command component, read the initial code in the command description file and then replace some parameters with the attribute value set by the user, and generate a command and send the same. If it is an event component, read the initial code in the event description file and assign the values of the event packet to user variables. If it is a system functional component, read the initial code in the system function description file and replace come parameters by attribute value set by the user, and create a function call. If it is an embedded code component, it will identify the embedded code type, if common code, it will be directly placed after the last component code; if a function, it will be placed before all component codes; if a status component, it will generate a Case statement with its ID; if a branch component, it will generate multiple Case statements according to the conditions; if a variable component, it will get the variable type and the default value, and generate the variable definition before component code; if a process entry component, do some initialization operation of process start; if a process exit component, do the process end processing.

From the above, we can see that the command component, event component and system functional component can generate standard C code after inquiring the relevant description files. If the description file shows that a parameter is a public parameter, it need to inquire the public parameter structure description file, while other structures can generate relevant C code directly according to the flow chart record file. For embedded code, the code should be directly placed after the last component code for embedded common code, but before all components in case of embedded function. For branch components, in order to process easily, all the codes should be completed with the Switch and Case statement, even for sub-branch components. There can be many variable components in process, the user can add, modify and delete any user variable with any variable component.

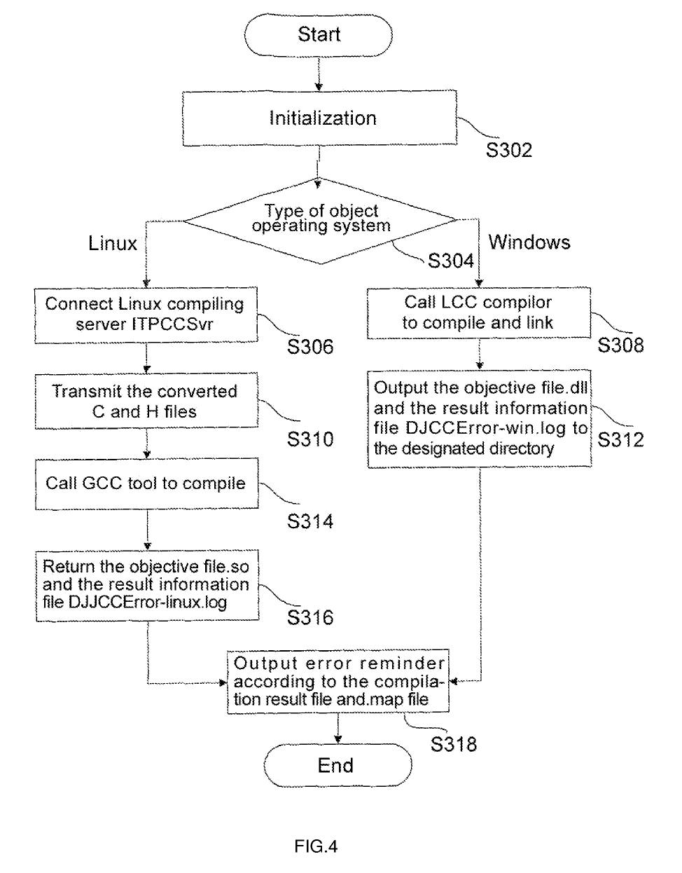

The process compilation module 4 need to use the command packets, event packets, public parameters and system function definition header file during compiling, and generate the relevant process conversion files according to the process record file. The process compilation module will call compilation tools provided by LCC (LCC is a language compilation tool, and a free 32-bit C language compilation system running on Windows 9x/Me/NT/2000) which meets the GPL standard (GPL, short for General Public License, is a general public license that free software uses). The compilation is completed by using the compilation tools provided by LCC, and the compilation mainly uses lcc.exe and lcclink.exe. The processing procedure of the process compilation module 4 is shown in FIG. 4.

Step S302: initialize, and set the compiling tool directory,

Step S304: identify the type of the targeted operating system; if it is the process dynamic library of Linux version, the user have to set the IP and port of the Linux compiling server, then call the compiling interface to compile the Windows or Linux dynamic library.

Step S306, S310, S314 and S316: In Linux, the program connects Linux compiling server (TTPCCSvr), then transmits all source files (c) and header files to the Linux compiling server by TCP/IP, compiles and links the source file and header file with LCC compilation tool, outputs the file so (dynamic library), then transmits the targeted so file to the specific directory with TCP/IP. If there is any error during the compiling, the error information will be written in the revelant record file DJCCError-linux.log (the DJCCError-linux is the file name), and Linux compiled service port will transmit the record file to the designated path.

Step S308 and S312: In Windows, the program calls the lcc.exe and lcclink.exe of the LCC compiling tool to compile and link (in Step S308), and the output file is .dll (dynamic library). If there is any error during the compiling, the error information will be written in the revelant record file DJCCError-win.log (in Step S312. DJCCError-win is the file name).

Step S318: The error information will be provided on the compilation result information interface according to the DJCCError-win.log, DJCCError-linux.log and the .map file generated by the conversion tool.(in S316)

This section aims to provide a case study only and shall not be used to limit the extent of the invention. Any amendment, modification, change, equivalent replacement or retrofit highlighting the essence and principle of this invention shall be deemed fall into the protection extent of the invention.

1. A process generation approach for computer telephony integration (CTI) of an integrated telecom platform; the technical features include the following steps:
Step 1: The process input module receives the flow chart input by a user and saves it as a flow chart record file;
Step 2: The process coversion module coverts the flow chart record file into the equivalent source codes and saves them as a flow chart coversion output file;
Step 3: The process compilation module compiles the flow chart coversion output file and saves it as a flow chart compilation output file.

2. The invention of claim 1, wherein the flow chart input by the user, in Step (S1), is saved in a computer in the format of flow chart record file, which has the equivalent contents with the flow chart so input.

3. The invention of claim 2, wherein the graphic process definition for the flow chart consists of at least one basic component connected in a certain way.

4. Based on the approach said in claim 1, Step (S2) of the invention also include the process to identify the component type of the flow chart record file and then inquire the description file corresponding to the same.

5. The invention of claim 1, wherein the source code adopts ANSI C language, and the coversion of the flow chart record file into ANSI C source code in Step (S2) is unidirectional.

6. The invention of claim 1, wherein the compilation in Step (S3) is to compile C source code of process definition with the standard C compiler in the operating system and output the process execution code.

7. The invention of claim 6, wherein the compilation output is a dynamic link library (DLL) file if the operating system is WIN32 and a dynamic library file if the operating system is Linux.

8. A process generation system for computer telephony integration (CTI) of an integrated telecom platform, which consists of
Process input module: it provides a graphic interface, receives the flow chart input by a user and saves it as a flow chart record file and then sends it to the process conversion module;
Process coversion module: it coverts the flow chart record file into equivalent source codes and saves them as a flow chart coversion output file, then sends it to the process compilation module;
Process compilation module: it compiles the flow chart coversion output file and saves it as a flow chart compilation output file.

9. The invention of claim 8, wherein the process input module includes basic components and auxiliary components. The basic components include initializing, functional, status, process restart and branch components; and the auxiliary components include detailed drawing, Help, flags and cycle components.

10. The invention of claim 8, wherein the process compilation module uses the compilation tools provided by Windows or Linux to do the compilation.

11. Based on the approach said in claim 3, Step (S2) of the invention also include the process to identify the component type of the flow chart record file and then inquire the description file corresponding to the same.

12. The invention of claim 5, wherein the compilation in Step (S3) is to compile C source code of process definition with the standard C compiler in the operating system and output the process execution code.
